(19) United States
(12) Patent Application Publication
(10) Pub. No.: US 2016/0299979 A1
(43) Pub. Date: Oct. 13, 2016

(54) PROCESSING A SEARCH QUERY AND RETREIVING RECORDS FROM A LOCAL AND SERVER SIDE DATABASE SYSTEM OF AN ELECTRONIC MESSAGING SYSTEM

(71) Applicants: Vinay Bawri, Kolkata (IN); Malvika Bawri, Kolkata (IN)

(72) Inventors: Vinay Bawri, Kolkata (IN); Malvika Bawri, Kolkata (IN)

(21) Appl. No.: 15/093,561

(22) Filed: Apr. 7, 2016

(30) Foreign Application Priority Data
Apr. 8, 2015 (IN) 1025/KOL/2014

(51) Int. Cl. G06F 17/30

(52) U.S. Cl. CPC G06F 17/30867; G06F 17/30554; G06F 17/3053

(57) ABSTRACT

Methods and systems are disclosed for searching, ranking, and displaying emails on email applications, such as Microsoft Outlook®, Gmail™, Yahoo!®, Hotmail®, Lotus Notes®, Thunder Bird®, electronic messaging software applications. The software application can include one or more database systems. The database systems may include one or more databases stored locally and/or remotely on a server. The methods and systems can retrieve records from the database system based on the search queries. Further, the records may be retrieved based on the identified context(s) of the user's input. The records may correspond to electronic mail (EMAIL). The retrieved records can be ranked based on predefined ranking algorithm. The ranking can be done according to the extent of relevancy of the search query. The records can be output to computing device.

### CROSS REFERENCE TO RELATED APPLICATIONS

This complete specification is filed in pursuance of the provisional Indian patent application numbered 1025/KOL/2014 filed at India Patent Office on 8 Apr. 2015.

### FIELD OF THE DISCLOSURE

The present invention relates to the field of computer processing and more particularly, to system and method for processing a search query and providing relevant emails or specific emails residing in database of email applications and/or residing in any data repository including but not exclusive of intranets, hard drive, storage device, cloud device, desktops, mobile device, etc.

### BACKGROUND OF THE DISCLOSURE

Many times it is very difficult to search and retrieve a specific email exchanged with a person or number of persons on desktop, web based, mobile or cloud email applications, such as Microsoft Outlook™, Gmail™, Yahoo!™, Hotmail™, Lotus Notes™, Thunder Bird™. Usually, in such email applications, the users use conventional inbuilt programs for searching and retrieval of emails, attachments and the like. The searching capabilities of such inbuilt programs are limited and have not kept pace with the sheer explosion in the number of emails that email users have today. Accordingly, the task of searching is usually time consuming and tedious.

Moreover, whenever a user searches for an email on an email application or in computing devices equipped with an email platform, in such a situation the user often has to spend a lot of time identifying the relevant email from the search results. Usually, the user has to scroll and go through a series of emails displayed in the search results to identify the email that the user is searching for.

Also, in conventional search interfaces, the user tries to find relevant email(s) by entering particular search term and/or search parameter such as sender name, subject of mail and the like. Even though, after the user has recursively entered various search terms, the user also needs to go through various emails to identify those emails which are relevant to his requirements. Sometimes, this process of searching for relevant email(s) is very time consuming and frustrating.

There is software like email plug-ins, browser plug-ins or other similar software like X1 that enable slightly more efficient searching and displaying of emails. Such software minimizes the tedious nature of searching for emails, attachments and the like in email clients or in other data repositories. For example, conventionally there exists searching software that enables displaying of emails chronologically. Moreover, few searching software enables displaying of emails based on the name of the persons and/or other search keyword terms. However, the ability of these searching programs is limited, and requires considerable improvement. Further, the intelligence of existing searching modules is limited and such software does not fully understand the user's search query/search terms. The algorithm and hierarchy pattern in such software are not advanced to present required emails as per the users requirement.

There are methods like as disclosed in the U.S. Pat. No. 8,745,045 by the inventors of the present patent application that discloses slightly more efficient way of searching and displaying of emails than the U.S. Pat. No. 8,745,045. The said granted patent discloses a plug-in or software for searching a mailbox of a user to identify and present results relevant to the user's requirements. However, the inventors feel that there is an opportunity to improve the ability of these plug-ins or software. Further, the intelligence of existing searching method of the software could be improved. The U.S. Pat. No. 8,745,045 by the inventors of this patent application, has been disclosed herein as a reference for better understanding of the present invention.

### SUMMARY

In light of the above objects, a system and method for searching emails and information contained in emails/users email inbox and other data repositories, is disclosed.

Accordingly, there is a need to develop a method and system to search, rank, filter, and display emails in order to provide the best possible result to a user right at the top of the results. Further, there is need of such method and system which is applied to or integrated into any kind of email application, data repository, desktop, cloud, mobile device or other devices where emails are stored or accessed. Furthermore, there is need of such to method and system to have advanced hierarchy patterns and algorithms. In this way, when users search for emails/information they will get more relevant results in accordance with their requirements.

Therefore, an object of the present invention is searching, ranking, filtering and displaying of emails based on predefined hierarchies and algorithms.

Another objective of the present invention is to perform intelligent searching.

These and other objects and advantages of the invention will be clear from the ensuing description.

The present invention provides methods and systems for intelligent searching, ranking and filtering of emails in a database or software or device where emails are viewed or accessed which include but are not limited to clients such as Microsoft Outlook™, Gmail™, Yahoo!™, Hotmail™, Lotus Notes™, Thunder Bird™, and the like. The method and system includes receiving one or more input from the user. The input is received as a text input, audio input, image input, video input, braille input, gesture input and the like. Further, the input is automatically received on behalf of the user from the user's electronic device or another electronic device that is searching for information in user's inbox on the user's behalf if it is programmed to do so. Further, the method and system includes identifying context corresponding to the users input or electronic (programmed) input on behalf of the user. Moreover, the identification of the context is done on the basis of pre-defined sets of contexts and algorithms.

Furthermore, when the method and system identifies the context, the method and system includes searching, wherein searching is performed in database containing emails which is an email client or in other software or device where emails are viewed or accessed. Further, the method and system includes ranking of the emails based on predefined ranking criteria. The more relevant the email, the higher it will be shown in the results. Finally, the method and system displays the ranked emails to the user.

These aspects of the present invention, along with the various features of novelty that characterize the present invention, are pointed out with particularity in the description annexed hereto and form a part of this present invention. For a better understanding of the present invention, its operating advantages, and the specific objects attained by its uses, reference should be made to the accompanying drawing and descriptive matter in which there is illustrated an exemplary embodiment of the present invention.

### DESCRIPTION OF THE DRAWINGS

The advantages and features of the present invention will become better understood with reference to the following detailed description taken in conjunction with the accompanying drawings, in which:

FIG. 1 illustrates a block diagram of a system 100 depicting the environment, according to an embodiment of the present invention;

FIG. 2 illustrates a flow diagram 200 for processing a search query, searching, ranking, filtering, and displaying emails to fulfill the objective of the invention, according to an embodiment of the present invention;

FIG. 2A illustrates various pre-defined contexts based on which the search is performed, according to an embodiment of the present invention;

FIG. 3 provides an illustration which shows various features based on which ranking is being done, according to an embodiment of the present invention;

FIG. 4 provides an illustration which shows various features based on which displaying is being done, according to an embodiment of the present invention; and

FIG. 5 illustrates an end to end flow diagram of the processing of search request, according to an embodiment of the present disclosure.

Like reference numerals refer to like parts throughout the description of several views of the drawing.

### DESCRIPTION OF THE INVENTION

The exemplary embodiments described herein detailed for illustrative purposes are subject to many variations. It should be emphasized, however, that the present invention is not limited to method and system for searching, ranking and displaying emails. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

The term “email client” as described hereinafter refers to any kind of application or online email clients, desktop email clients, data repository (physical and/or virtual), and the like, that enables communication and/or storage of email or data related to email. The email client is selected from any of a passive type or an instant type email client. The term “email client” and “email application” have been used interchangeably hereinafter.

The term “computing device” as described hereinafter refers to a device that is processor driven and is compatible to run email clients and/or is compatible to connect to such data repositories, physical or virtual, which store email or data related to emails. The computing device includes but is not limited to computer, mobile, Personal Digital Assistant (PDA) and the like.

The term “input search query” as described hereinafter refers to an input made by user or made (programmed, authorized by) on behalf of user. The input is received as a text input, audio input, image input, video input, braille input, gesture input and the like. The input is automatically received on behalf of the user from the user's electronic device or another electronic device that is searching for information in user's inbox on the user's behalf if it is programmed to do so.

It will be apparent to a person skilled in the art that the present searching capabilities of conventional email clients are limited and have not kept pace with the sheer explosion in the number of emails that email users have today. Accordingly, the task of searching emails in email clients of computing systems are usually time consuming and tedious. Further, the conventional email clients require the user to spend a lot of time identifying the relevant email from the search results. This consumes extra processing time and hence is undesirable. This problem needs to be technically solved. Further, these clients require the user to scroll and go through a series of emails displayed in the search results to identify the email that the user is searching for.

The present invention provides system and method for searching emails in an email client, ranking them in a predefined format and displaying the search results to a user.

The said email client is selected from any of the online or LAN type platform, cloud based platform, mobile based platform and the like platform and is selected from an email application which is virtual or which is downloadable on local desktop machines or PDA devices being used by the users. Suitable examples of such email applications include Microsoft Outlook™, Gmail™, Yahoo!™, Hotmail™, Lotus Notes™, Thunder Bird™, and other instant and passive email applications available in the art. Emails refer to short text strings shared between users of email applications. The term “email” as used herein refers to conversations between more than one users of the email application.

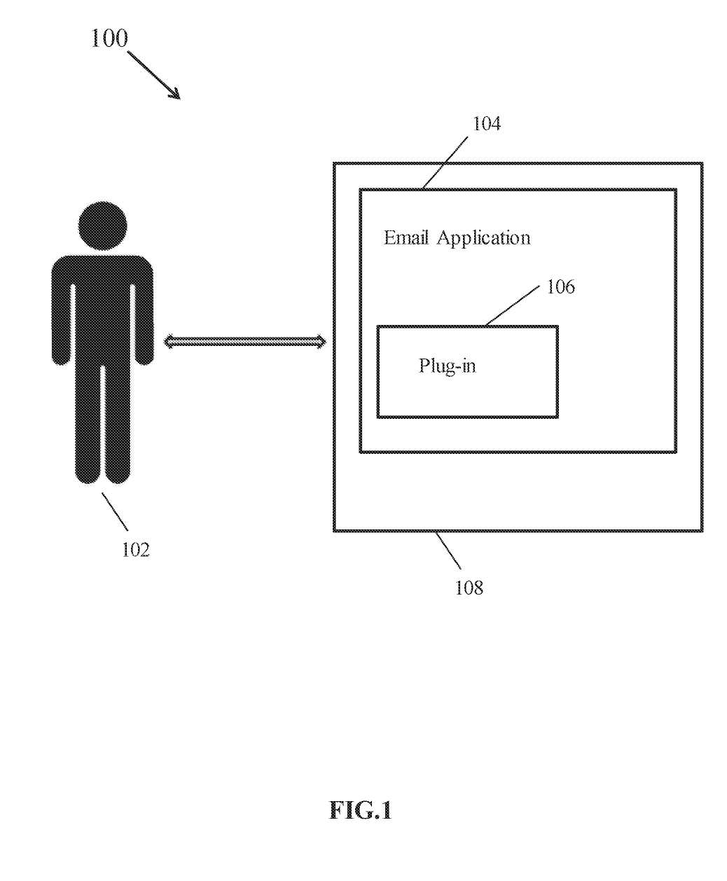

The system and method of the present invention is adapted to perform searching, ranking, filtering, and displaying of email results with the help of a computer assisted platform such as an email client, a plug-in, an add-on program, or other similar platform. Wherein, such computer assisted platform is connected with a server having an email database. The searching, ranking, filtering and displaying of email results are based on one or more pre-defined contexts and algorithms. The systems and methods and the algorithms used will now be explained in conjunction with FIGS. 1-4 as below.

In an embodiment of the present invention, the system and method for searching, ranking, and managing emails is done through a plug-in, or an independent application or any platform that is connected to email clients. Hence, hereinafter the term “plug-in” should be understood having similar meaning.

Now referring to FIG. 1, a system 100 has been shown where the implementation of the invention is illustrated with respect to the environment. FIG. 1 includes a user 102. The user 102 is shown to be using a computing device 108. Further, the system 100 includes an email application 104. Suitable examples of the email application 104 include, but are not limited to, Microsoft Outlook®, Gmail™, Yahoo!®, Hotmail®, Lotus Notes®, Thunder Bird®, and other such email applications. The system and method as per various embodiments of the present invention allow searching, ranking, filtering and displaying of emails on these email applications or in a database that contains emails.

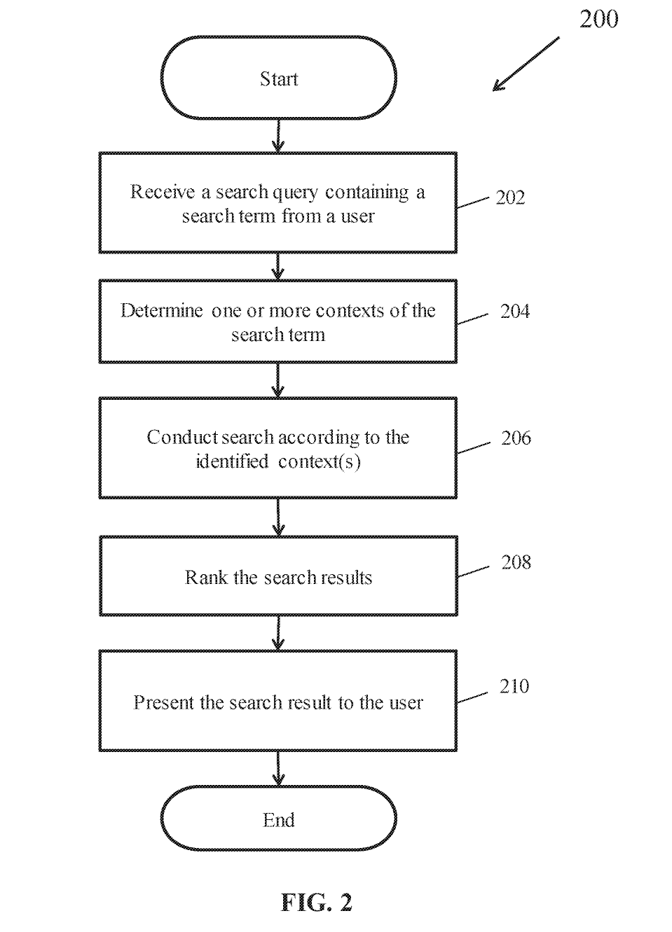

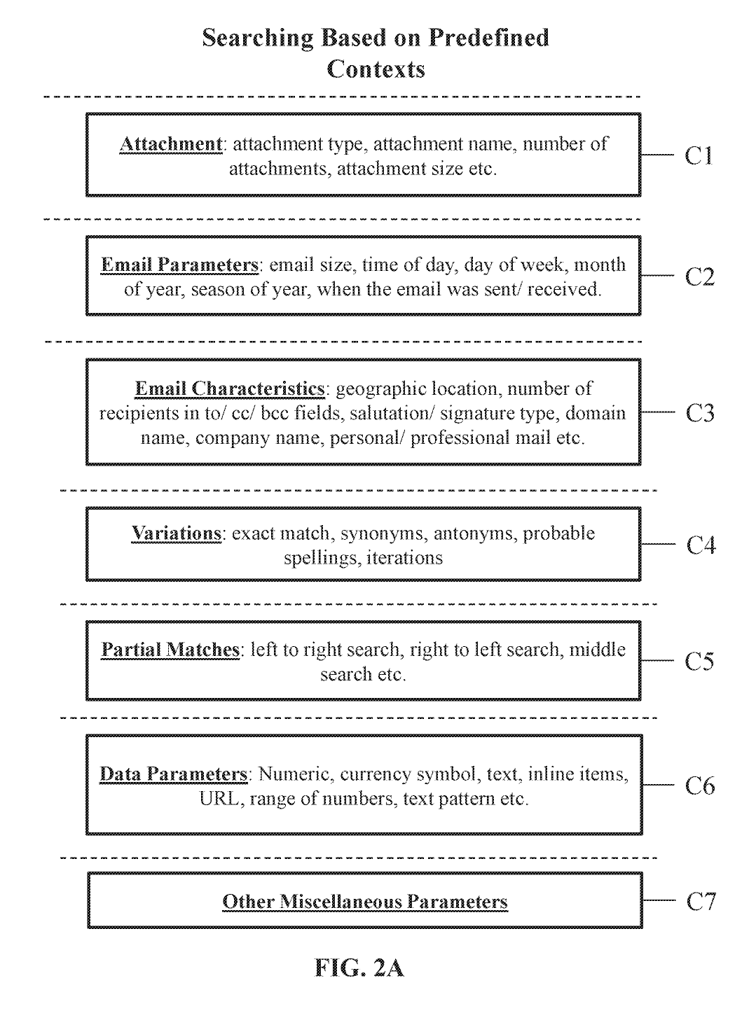

In an embodiment, the present system and method uses the means of a plug-in 106 or other similar platform connected to the email application 104. The plug-in 106 performs various types of searches to identify relevant emails before ranking them. The functioning of the plug-in 106 is explained with reference to FIGS. 2-4.

In FIG. 1, the plug-in 106 is illustrated as an “add on” installed inside the email application 104. However, in an embodiment, the plug-in 106 is an exclusive interface that is connected to multiple email clients simultaneously.

Now referring to FIGS. 2-2A, a method 200 for searching, ranking, filtering, and displaying of emails is shown. This method is embodied in the plug-in 106 or other similar platform of the present invention. As shown in FIG. 2, there is illustrated the basic steps to fulfill the objective of the invention. The method starts, at step 202. The method at this step 202 receives one or more search query including search term from a user or from the user's electronic device or other device on behalf of the user.

Accordingly, as per one embodiment of the present invention, when user 102 wishes to search for a particular keyword(s) or search term(s), then the user can input the search term(s) in the search box of the interface provided by plug-in or other similar platform 106.

As per another embodiment, the input is in the form of one or more keywords or a string of words or other input search query. In addition to providing one or more search terms, the user may opt to select one of the advanced search options given in the drop-down menu provided by plug-in 106. For example, the user can input “patent” as a search term.

The method then flows to step 204. At step 204, the method determines one or more contexts for the search. In various embodiments of the present invention, the context of search is identified by referencing to pre-defined identification contexts.

The pre-defined identification contexts C1-C7 include suggestions that the user is looking for the following but not are not limited to “attachment”, “attachment type” “attachment name with attachment type,” “number of attachments”, “attachment size”, email parameters, such as “email size”, “time of day”, “day of week”, “month of the year”, “season of the year”, email characteristics, such as “geo location of sender and recipients”, “number of recipients” “number of recipients in the cc field in the email”, “salutation type the sender has used in the email”, “signature type the sender has used in the email”, “domain name,” “company name”, “personal or professional email”, “person,” and “general term” which includes the subject line of the e-mail, the body of the e-mail as well as the “attachment name” and “headers” of the e-mail if any.

As per the example illustrated above, in case the user may input “patent” as a search term, at step 204, the method determines at least one context of the search using the received user input. In such case, the plug-in 106 determines the context out of pre-defined contexts. For example, for input “patent”, it is determined that the user is looking for a document that has term “patent” in the file name. Further, at step 206, the method conducts a search according to the identified context(s).

Further the method moves to step 208, where the method ranks the results of the search. In various embodiments of the present invention, the ranking is done as per predefined hierarchies.

Finally, at step 210, the method displays/presents the results according to a predefined rank order. Thereafter, the method terminates.

In various embodiments of the present invention, the searching is done by parsing the search term or a context of the search term, in several other predefined contexts. In accordance with an embodiment, the method and system is capable of searching for synonyms of search term, antonyms of search terms and variation of words of the search term. Specifically, if the system does not get any “exact match” for the search term, then the system searches for synonyms, antonyms and variation of words. For example, if the search term is “book” then the method may show results related to say “novel”, “volume”, “tome” and the like. These results will be presented to the user if the method and system does not locate any match for search term “book”.

As per another embodiment, the method and system searches for “input search query” and corresponding emails based on spelling errors, acronyms, singular and plural, nouns and verb like “UNO” equals “United Nation Organization”, nations and nation, move and moving; so if the system does not find one, it can search for the other automatically or when prompted by the user.

More specifically, the method and system is intelligent enough to understand the correct spelling of a misspelt word. For example, if the user enters the search term “knowlede” by mistake, then the method will show the results related to “knowledge”. Similarly, this process is followed for other parameters like acronyms, punctuations, singular and plural terms nouns and verbs, etc. As an example when a user searches for “nation” it will also search for “nations”, “nationality”, “national” etc. when the search term “nation” is not found or in addition to the instance when the search term “nation” is found. This additional/alternative search is initiated by the user and/or automatically by the system.

As per another embodiment, the method and system first matches all the words of the search term and then some of the words. Specifically, if the user enters two words as a search term, then the method first searches for those two words as contiguous. Moreover, if the method does not get any exact match for those two words as a whole, then further it searches for both the terms individually. For example, if the user enters the search term “patent process”, then the method searches for both the terms as entered i.e. adjacent to each other. Further, if the method does not get any result then the method searches for the term “patent” separately followed by a search for the term “process”.

In another embodiment, the method and system first looks for a perfect match to the search term where the input and output are identical and, then searches for a partial match or the search term from left to right, then right to left and finally looks for matches in the middle of the term. For example, if the user enters “think” as a search term, then the system first searches for a perfect match for the term “think” and then looks for a match from left to right and right to left. If there are no results for the term “think”, the system searches for results where the search term “think” is in the middle of a term. The method and system may return results such as “thinktank”. Such intelligent searching is performed based on pre-defined algorithms. It would be obvious to those skilled in the art, that this intelligent searching may not be limited to emails alone, but can be used for searching documents, desktop search and the like.

In yet another embodiment, the method and system is capable of searching based on “iterations” of the search term. For example, what is referred to as “soda” in America is referred to as “soft drink” in other parts of the world. So in instances where the system cannot find one version of the search term like “soda” it looks for the term “soft drink” or when a user enters “Bill” as a search term the system will search for “William” when it cannot find the search term “Bill” as “Bill” is sometimes an abbreviation of the name “William”.

In yet another embodiment, the present system and method is adapted to search by providing data parameter as mentioned below:
a) Numeric: users can find any email which has a numeric in it, e.g. 34 or displayed as a currency like $34, further, the numeric from dates in the body of the email are first identified and removed as these dates are always in certain pre-defined format;
b) Currency Symbol: any email which has a currency symbol in it (a pre-loaded list of currencies is available in the system for such identification). This feature of the system is very useful when users are looking for an email which may have the following text “order value is $1000”;
c) Currency Text: any email which has a currency text in it (a pre-loaded list of the text of all currencies available in the system for such identification). This feature of the method and system is very useful when users are looking for an email which may have the following text “order value is 1000 dollars” or “order value is thousand dollars”;
d) Inline Items: users today attach inline tables, photos, attachments, as well as inline user comments in emails. A search parameter which can identify the said inline items is provided in the system;
e) Number of Attachments: a user can search for number of attachments in an email, the user can specify the number of attachments or specify mails which have >n attachments, where n is the number of attachments. The user can also specify <n attachments and the aforesaid is used in conjunction or separately as per the need of the user;
f) URL: a user can search for one or more URLs or hyperlinks mentioned in an email;
g) Range of Numbers: the method and system searches for a range of numbers like if the user enters $1025, the system returns results based on numbers closest to $1025 like $1026 and $1024. This is for instances where the user cannot remember the exact number;
h) Synonyms: the method and system searches for synonyms/antonyms of the search term if the system is not able to locate the search term. For instance if the user enters the search term “product”, the system looks for emails for the word product. If the system does not return any result for “product”, it searches for synonyms of the word like produce, goods, output etc.;
i) Similar Text Pattern: the method and system locates similar mails which have the same text pattern like spacing, color, font, etc. This is very useful when the user is trying to locate say a set of poems, or a mail which contain software code in the body.

The above is used to rank emails as well as to search for particular emails which the user may remember as having these characteristics

There are scenarios when it becomes necessary to quickly find the most important emails in a database. To achieve such results, the system and method is further adapted to search by providing data parameter as mentioned below:
i) searches for emails that are especially longer or shorter than other emails;
ii) searches for emails which have bullet points or similar formatting;
iii) searches for emails which have the word “confidential” or similar phrases like “keep it confidential” or synonyms of the same which the law enforcement agency can choose out of;
iv) searches for emails that are specifically encrypted;
v) searches for emails that originate in the same geo location;
vi) searches for emails that are from the same IP (internet protocol) address;
vii) searches for emails that are from the same sender but that constantly have different IP addresses;
viii) searches for emails that are from the same type of device, as an example all emails that were sent from an iPhone 5 to an iPhone 5;
ix) searches for emails that are from the same device and same date or a date range. As an example all emails that were sent from an iPhone 5 to an iPhone 5 on Jan. 5, 2015 or between Jan. 5, 2015 and Jan. 4, 2016.

Similarly in a LAN environment or a corporate environment where all the computers in the network may not be directly connected, the system can find the emails which are available on multiple computers. This would help auditors or law enforcement agencies find the information and it would also help them know that the information was circulated in the organization or that it was commonly known and when it became commonly known.

Further, a trail is established of who knows whom in the organization and how intimately, based on:
i) whether, Person A ever emailed only Person B and how many times;
ii) whether, Person A emailed Person B but person B is always in the Cc line.

The above mentioned features relate to the field of searching, providing a vast and advanced algorithm to the user. The features as a whole in an algorithm is retrieving relevant result and thus saving time for the user.

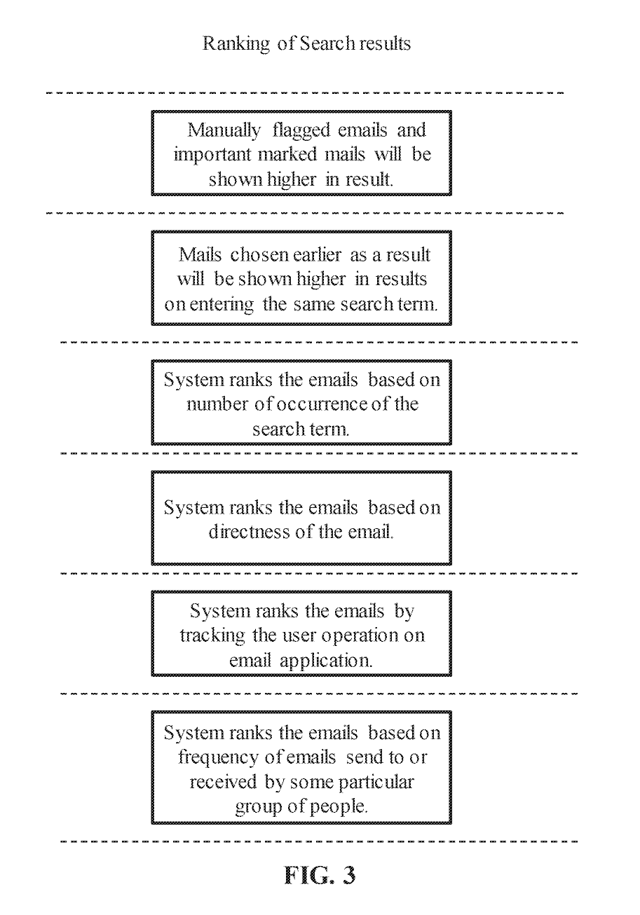

FIG. 3 is an illustration for showing certain ranking features according to various embodiments of the present invention. In the illustration, there is shown few exemplary ranking criteria, according to various embodiments of the present invention. The ranking of search results is done based on a predefined ranking criteria, in various ways as to explained below.

As per another embodiment, the system may rank the search results, by displaying manually flagged emails and mails which are currently or have been previously marked as important by the user. Specifically, the system shows matching emails to the search term which have been marked as important by the user at the top of the results. For example, if there are 5 matching results to the search term and two of them have been marked as important or flagged manually by the user at some point in time, then these results would be shown at the top of the search results. The system and method would keep track of emails which are currently flagged or which have been flagged earlier at some point in time. Similarly, emails which have been categorized, color coded, starred and marked with such other markers (depending on the email client and the options provided) is shown at the top of the results. Further, such other markers varies form one email client to another email client.

Emails that have been marked as important from people the user corresponds with more often, like company the user works at and/or users family and/or close friends will be shown above emails marked as important from people the user doesn't correspond with that often. It should be understood that the various algorithms is used independently or in any combination.

In yet another embodiment, the method will rank the results based on number of occurrence of word (search term). Specifically, those results will be shown higher in results which include the search term more number of times. For example, a result including the search term five times will be shown higher as compared to the result including the search term three times.

In yet another embodiment, the method and system ranks the emails based on directness of the email. For example when a user searches for an email that the user (Mary) received from (Bob) by entering the search query From: Bob To: Mary in advanced email search, the system will display focused and intelligent results to such input search queries. At the top of the results to the search query the system will display a set of the latest direct email exchanges between only Bob and Mary. This means that these emails would have been sent from Bob to Mary, with no other recipients in the To: or Cc: fields.

Further, the method and system will display the next set of results which has other recipients in the “To:” field but limited to a specific number, say 3 recipients in total instead of 1 recipient as in the example above.

Further, the method and system will display the next set of results which has other recipients in the “Cc:” field but limited to a specific number say 1 recipient.

Further, the method and system will display the next set of results which has other recipients in the “Cc:” field but limited to a specific number say 3 recipients in total instead of 1 recipient as in the example above.

Further, the method and system will show emails which have more than 3 but less than say 7 recipients in the “To:” and “Cc:” fields.

After this the method and system will show all other results, i.e. which have 7 or more recipients in the “to:” “cc:” field. This is done in order to show more focused results to the user. It has been our experience that when a user searches for an email from a particular sender by specifying a From: and To: Sender and Recipient, the user is more likely to search for direct email exchanges and the method proposes to show these emails at the top instead of showing all the mails chronologically by descending order of date.

In order to ensure that latest emails, even though less important emails are not lost in the process of presenting the results, the system limits the results either by a time frame, say 1 week or one month or by a number of results, i.e. first display 10 latest results (if available) which have only emails From: Bob to Mary with no other recipients in the To: Cc: field, next display 10 latest emails from Bob: to Mary: which has 3 or less recipients in total in the From: cc: field and so on, or a combination of both. This is done to ensure that recent emails are displayed first and the emails which are much older, say five years old emails are not displayed at the top of the results.

The method and system can provide an option of “searching for more results” if the said email is not found within the results that are displayed for one year or the system chooses to do it automatically.

The method and system will take into account, the user's preferences and actions and will alter the display of emails based on the user preferences. In an embodiment, the ranking is changed dynamically based on user search history. For example, the user's search pattern is identified corresponding to the results provided. Based on this, the method checks whether the user actually found results relevant to his search. And if not, the ranking process is dynamically changed and results are then searched/ranked differently.

Whether the user actually found relevant results, is checked by the method by ways including but not limited to, if user quickly searches again after ranked results are presented, if user changes the input searches slightly (in order to narrow down results) after ranked search results are presented, the amount of time user takes to read/reply/close the ranked results presented, etc.

In yet another embodiment, the method ranks the emails based on frequency of emails sent to or received from a particular group of people/a particular company, domain name, etc. For example, emails from frequently mailed users and/or from people the user is closely associated with like colleagues, close family, etc., will be shown at the top of the results.

The above mentioned features relate to the field of ranking, providing a vast and advanced algorithm to the user. The features as a whole in an algorithm are retrieving and ranking relevant result at the top thus saving the user's precious time.

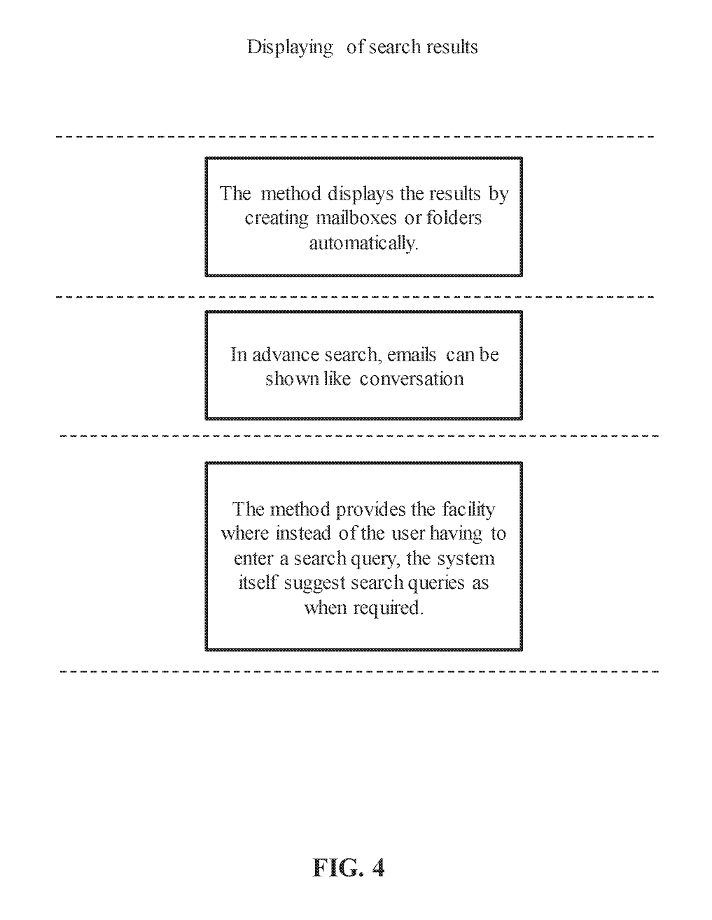

Now referring to FIG. 4, an illustration of displaying features has been shown, according to various embodiments of the present invention. In the illustration, there are shown few exemplary displaying criteria, according to various embodiments of the present invention.

In an embodiment, the method and system displays the results based on a predefined criteria, by creating partition(s) in display screens of computing device or by creating folders automatically. In an embodiment, the system displays the results by creating folders automatically. Specifically, the method automatically creates separate folders based on pre-defined algorithms. This will help users to separate emails based in different folders/groups i.e. a personal email folder, a work email folder, a friend circle folder, a business email folder, a health/wellness/fitness email folder, a life partner email folder, an event email folder etc. These folders are created by using a combination of sender and receivers in the To: and cc: field and the subject line of the email.

In an implementation, the user customizes the settings so that the present system and method of searching, ranking and managing emails show a particular number or percentage of results out of ranked search results. For example, if the user searches for “From: Anne To: Mike” and the present method has 20 results ranked on the basis of several hierarchies disclosed above. The user can customize the method to show only 25% of top ranked results. In another aspect, the user can customize the method to show only some percent of remaining results over a set limit. Say, a user inputs a search term and the method generates 50 ranked results, the user can opt a limit of top 10 results and 25% of remaining top results.

The method and system locates users who have frequently communicated with each other, users who have never communicated with each other, whether the emails have attachments and if so which type of attachments, number of occurrences of a word in the conversations, in order to create the mailboxes. For example, Person A has communicated with Person B, C, and D by either sending an email to them or receiving an email from any of them. Through this, it is inferred that Person A is connected with Persons B, C and D and also that persons B, C and D know each other in some context or capacity. Further, groups of persons who communicate regularly with each other are also used to automatically create the mailboxes.

The method and system locates persons who have never communicated with each other or sets of persons who regularly communicate with each other using the following conditions, say:
(i) Person E has never sent an email or received an email to/from Persons A, B, C, D;
(ii) Person E has never been marked in a communication between Persons A, B, C, D.

In another example, Persons E, F, G, H communicate regularly with each other in a group where either one of Persons E, F, G, H initiate a conversation.

Further to create the mailbox, the method and system looks at the number of occurrences of a certain word to create the mailbox. Thus, the mailbox is automatically created around groups of people, companies, domain name, duration of time, or topic or a composite of these factors. This process greatly helps in segregating mails based on context.

Further the method and system is adapted to segregate emails between domains like whether person A and Person B share the same domain in their email address or not; and whether, there are a number of emails which are marked to recipients from the same domain including that of the user from which it is reasonably ascertained that the domain belongs to a company/institution and mails from that domain are segregated separately, if required. In another embodiment, the method and system maintains and updates a list of commercial or free email providers like Gmail and not apply the criterion mentioned above to mails from the said domains.

In yet another embodiment, the method displays the emails in form of conversations. For example, if the user searches for an email by entering, say From: Bob To: Mary in advanced search, the user can also view two way conversations i.e. the emails From: Bob To: Mary as well as the emails From: Mary To: Bob in the same search result. Being able to view entire conversations between persons or groups of people would help the user a lot when the user is trying to recollect the information/mails and the context of the same that have been exchanged between two or more people, say Bob and Mary.

The system is adapted so that users are given an option of viewing entire conversations. To this end, users are given an option like “view conversation” after they search which will mean that users can view two way email exchanges from Bob to Mary and from Mary to Bob in the same search result.

Another implementation of this feature also gives additional fields in simple or in advanced search, for example:

From: Bob

to To: Mary;

From: Mary

To: Bob

Giving this multiple option will ensure that entire conversations are shown in the search results. This is implemented by providing a check box in advanced search like the following:

From: Bob

To: Mary

<Check box> view both sided conversations

This is implemented in advanced search.

In yet another embodiment, the system is capable of suggesting to the user to enter a search query. For example, the system can present the email addresses of frequently emailed users and/or recently emailed users who have a high frequency of email exchanges.

The system can provide a list of subjects, topics, persons, keywords, email addresses in a drop down menu through which the user can easily scroll through. For example the system can provide a list of the subjects that are contained in the emails in the user's inbox. In a single click the user can quickly scroll through the subjects in their inbox. The user can then quickly view emails on a particular subject.

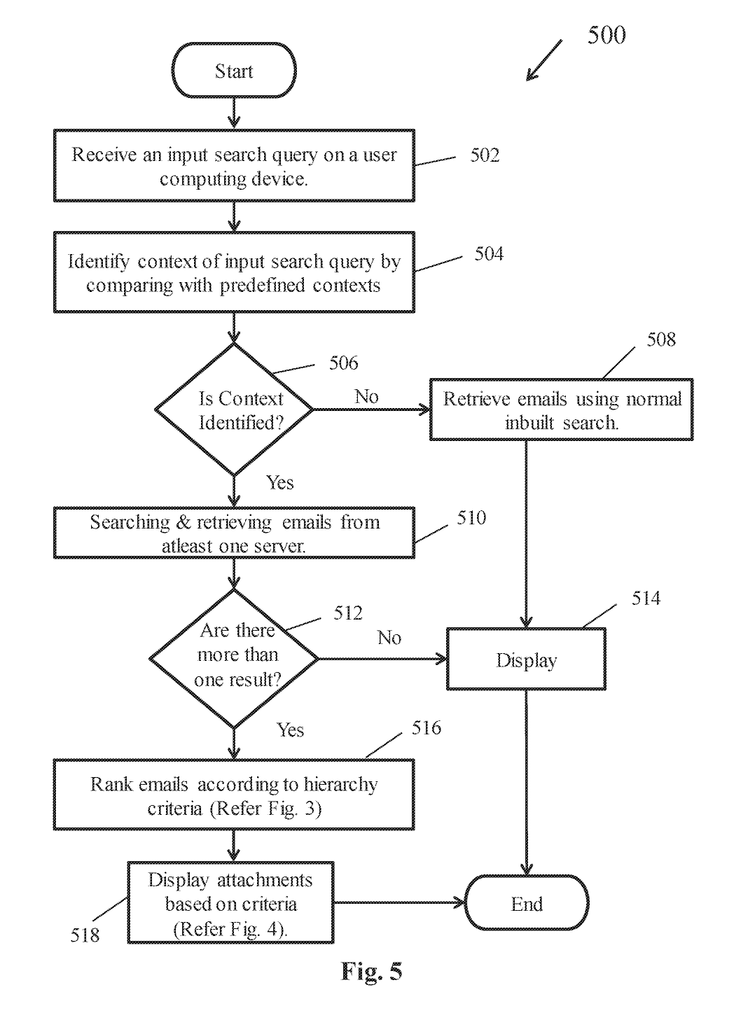

In an exemplary embodiment of the present invention, FIG. 5 illustrates end to end implementation of the present computer-implemented method for searching, ranking and managing emails over an email client connected with at least one server. The method 500 starts at 502 when a search query is input on a user computing device. The method then at step 504 identifies the context of the input search query from predefined contexts. Further, the method at 506 determines if the context of the input search query has been identified. If not, the searching of the email proceeds with normal process of the inbuilt search engine of email client or application as show at 508. If at 506 it is identified that the input search query is among the predefined contexts then the method 500 proceeds to step 510.

According to various embodiments of the present invention, at step 510, the email(s) are searched and retrieved from email clients/databases/applications of at least one server based on identified search context in previous steps. At step 512, number of retrieved search results (emails) is determined. If the result is one, then the method proceeds to step 514 which displays the said result and the method stops.

In an embodiment, the results determined at 512 are more than one. In such a case the method moves to step 516 where the results are ranked according to various hierarchy criteria (as disclosed in FIG. 3). Now, the displaying, at step 518, of the ranked results is also done based on different criteria disclosed in FIG. 4. The method hence comes to an end.

The system can provide a list of recently used attachment types like .doc .xls which the user can click on. Instead of the user entering a search term, the system can pre-populate a list of search terms which it deems the user is likely to search for.

The computer implemented methods for searching and ranking as disclosed in the present invention provides faster computation time, reduces the processing burden on processing elements of a computer, and increases the quality of the emails retrieved in an email client. The disclosed searching algorithms which are based on identification of context of the inputted search term and the subsequent ranking algorithm eases the computing load on a computer processor and significantly increases the relevance of the emails retrieved in an email client running on a computing system.

Further, the present invention should not be construed to be limited to the configuration of the method and system as described herein only. Various configurations of the system are possible which shall also lie within the scope of the present invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

The system, as described in the disclosed teachings or any of its components, is embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

In a computer system comprising a general purpose computer, such may include an input device, and a display unit. Specifically, the computer may comprise a microprocessor, where the microprocessor is connected to a communication bus. The computer may also include a memory the memory may include Random Access Memory (RAM) and Read Only Memory (ROM). The computer system further comprises a storage device it can be a hard disk drive or a removable storage drive such as a floppy disk drive, optical disk drive, and the like. The storage device can also comprise other, similar means for loading computer programs or other instructions into the computer system.

The computer system may comprise a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

The computer system executes a set of instructions that are stored in one or more storage elements in order to process input data. The storage elements may also hold data or other information as desired. The storage element is selected from but not limited to an information source or a physical memory element present in the processing machine.

The set of instructions may include various commands that instruct the processing machine to perform specific tasks such as the steps that constitute the method of the disclosed teachings. The set of instructions is selected from but not limited to in the form of a software program. The software is selected from but not limited to various forms such as system software or application software. Further, the software might be in the form of a collection of separate programs, a program module with a larger program or a portion of a program module. The software might also include modular programming in the form of object-oriented programming. The software program or programs are selected from but not limited to a computer program product, such as in the form of a computer readable medium with the program or programs including the set of instructions embodied therein. The processing of input data by the processing machine is in response to user commands or in response to the results of previous processing or in response to a request made by another processing machine.

What is claimed is:

1. A computer-implemented method for searching, ranking and managing emails over an email client connected with at least one server, the computer-implemented method comprising:
receiving at least one input search query from a user over a user interface of the email client;
identifying a search context, wherein the search context is identified based on the input search query;
searching one or more emails over the email client, wherein said searching is based on at least one search context;
identifying at least one desired email result from the said searched one or more emails, the said at least one desired email result based on a predefined identification context;
ranking at least one desired email result, wherein the ranking is based on at least one predefined ranking criteria; and
displaying the said ranked one or more email results based on a predefined criteria, wherein the results are displayed through a user computing device of the user.

2. The computer-implemented method as claimed in claim 1, wherein the search context is selected from at least an email attachment, content of the email, or a combination thereof.

3. The computer-implemented method as claimed in claim 2, wherein at least an email attachment comprises an attachment type, an attachment name, an attachment content, and a combination thereof.

4. The computer-implemented method as claimed in claim 2, wherein the content of the email comprises a subject line of the e-mail, a body of the e-mail, an email domain name, a sender name, a receiver name, and a combination thereof.

5. The computer-implemented method as claimed in claim 1, wherein searching one or more emails over an email database comprises searching at least one of,
a content having an exact match of the input search query,
synonyms of the input search query,
antonyms of the input search query,
variation of words of the input search query, wherein variation of words comprises different word spellings of different geographical locations having same meaning,
iterations of the input search query, wherein iterations comprises different words that are used in different geographical locations having same meaning,
spelling of the input search query,
acronyms of the input search query,
to punctuations of the input search query,
singular and plural nouns of the of the input search query,
all terms of the input search query, and
at least one term of the input search query.

6. The computer-implemented method as claimed in claim 1, wherein searching one or more emails over an email database of the email client further comprises searching at least one of the content having numeric similar to the input search query, currency symbol similar to the input search query, currency text similar to the input search query, range of number similar to the input search query, attachment name similar to the input search query, and text patterns similar to the input search query.

7. The computer-implemented method as claimed in claim 1, wherein searching one or more emails over an email database of the email client further comprises searching at least one of a computing device, a plurality of computing devices having a plurality of email accounts of single email client or different email clients.

8. The computer-implemented method as claimed in claim 1, wherein identifying at least one desired email result comprises identifying at least one of,
all the search terms of the input search query present adjacent to each other,
all the search terms of the input search query present from left to right,
all the search terms of the input search query present from right to left, and
all the search terms of the input search query present in the middle of the search content.

9. The computer-implemented method as claimed in claim 1, wherein identifying at least one desired email result is based on the identification context, wherein the identification context comprises at least one of,
email content size, email having special character; email having special formatting, email having confidential wording; email marked as urgent, email inline items related to the input search query, email attachment number related to the input search query, email sender information, email receiver information, email co-sender information, email co-receiver information, and email URLs related to the input search query.

10. The computer-implemented method as claimed in claim 1, wherein ranking at least one desired email result is based on at least one predefined ranking criteria, wherein the such predefined ranking criteria is at least one of an email search result marked as important, at least an email search result which is flagged, at least an email search result which is color coded, user's previous selection of search results for the same search query, most often used email addresses, wherein most often used email addresses are at least a sender, a receiver, a co-sender, or a co-receiver email address.

11. The computer-implemented method as claimed in claim 1, wherein ranking at least one of desired email result is further based on number of occurrence of search term in a search result, directness of the email, wherein directness of the email is based on the sender and receiver information, the co-sender and co-receiver information, and a combination thereof.

12. The computer-implemented method as claimed in claim 1, wherein ranking comprises ranking based on at least one of a number of recipients, wherein number of recipient comprises at least one recipient, at least two recipients, at least three recipients, at least seven recipients, or more than seven recipients.

13. The computer-implemented method as claimed in claim 1, wherein displaying comprises displaying at least one of a highly ranked to lowest ranked results, displaying results based on email frequency to and from a particular email address, displaying entire conversation between the sender and the receiver, displaying results based on user preferences, and displaying results based on user actions.

14. The computer-implemented method as claimed in claim 1, wherein managing emails over the email client comprises automatically creating plurality of separate mailboxes, wherein plurality of separate mailboxes comprises at least one of mailbox for office emails, mailbox for personal emails, mailbox for frequently used email contacts, mailbox for a groups of persons, mailbox for a groups of topics, mailbox for emails with attachments, mailbox for emails having frequently used words, mailbox for same domain emails, mailbox for social networking emails, and mailbox for promotional emails.

15. The computer-implemented method as claimed in claim 14, wherein plurality of separate mailboxes are adapted to automatically segregate plurality of different emails.

16. The computer-implemented method as claimed in claim 1, wherein the user interface of the email client is adapted to provide a plurality of search suggestions to the users, wherein the plurality of search suggestions are based on the frequently used emails address, previous used search terms, email domain names, and email attachment types.
